(19) United States
(12) Patent Application Publication
(10) Pub. No.: US 2024/0018915 A1
(43) Pub. Date: Jan. 18, 2024

(54) AMMONIA-HYDROGEN FUSION FUEL DIFFUSION COMBUSTION CONTROL SYSTEM BASED ON REACTIVITY REGULATION

(71) Applicants: DONGFENG HONDA ENGINE CO.,LTD., Guangzhou (CN); Tianjin University, Tianjin (CN)

(72) Inventors: Zhibin Zeng, Guangzhou (CN); Min Zhuang, Guangzhou (CN); Guanghui Jiang, Guangzhou (CN); Jiaxiong Wei, Guangzhou (CN); Lei Zhou, Tianjin (CN); Zongkuan Liu, Tianjin (CN); Haiqiao Wei, Tianjin (CN)

(21) Appl. No.: 18/120,651

(22) Filed: Mar. 13, 2023

(30) Foreign Application Priority Data
Jul. 15, 2022 (CN) 2022108307027

(51) Int. Cl. F02D 19/06; F02B 19/12; F02B 19/10; F02B 25/02; F02D 21/02; F02B 19/16; F02P 5/15

(52) U.S. Cl. CPC F02D 19/0639; F02D 19/0671; F02D 19/0689; F02D 19/0692; F02B 19/12; F02B 19/1023; F02D 19/0665; F02B 25/02; F02D 21/02; F02B 19/16; F02P 5/1502; F02B 19/1085

(57) ABSTRACT

The present invention discloses an ammonia-hydrogen fusion fuel diffusion combustion control system based on reactivity regulation, comprising an on-board ammonia-hydrogen fuel supply system, an ammonia-hydrogen fusion fuel diffusion combustion engine and an ECU; the ECU is used to control the intensity of a precombustion chamber jet flame, control the reactivity of a hydrogen-air mixture in a main combustion chamber and control the injection time of an ammonia ejector, thus to form diffusion combustion in the main combustion chamber; the on-board ammonia-hydrogen fuel supply system comprises a low-pressure ammonia fuel supply unit and an on-board hydrogen production unit, and is used to provide prepared low-pressure ammonia fuel and hydrogen for the ammonia-hydrogen fusion fuel diffusion combustion engine; before the formation of the precombustion chamber jet flame, hydrogen regulated by the ECU is firstly injected into the main combustion chamber by a first hydrogen ejector, and then the injection time of the ammonia ejector is controlled by the ECU to be slightly earlier than or synchronous with the formation of the precombustion chamber jet flame, so that ammonia fuel injected into the main combustion chamber is in a state of burning while injecting, thus to form diffusion combustion in the main combustion chamber.

### TECHNICAL FIELD

The present invention belongs to the technical field of internal combustion engines, and particularly relates to an ammonia-hydrogen fusion fuel diffusion combustion control system based on reactivity regulation.

### BACKGROUND

Global climate and environmental changes have posed severe challenges to human economic and social development. Low-carbon or even zero-carbon development has become an inevitable trend of world economic development, and low-carbon technology will become a new “engine” for global economic development. Internal combustion engines, as a leading power of road and non-road mobile machinery and national defense equipment with a large capacity and a wide range, accounts for 10% of China's carbon emission from combustion. While shouldering the important mission of energy saving and emission reduction in the short and medium term, internal combustion engines also face a great challenge and important opportunity of how to achieve carbon neutrality in the future. Academician Huang Zhen from Shanghai Jiao Tong University comments that in the short and medium term, it is necessary to continually improve the thermal efficiency of internal combustion power to achieve the purpose of energy saving and carbon reduction. In the medium and long term, internal combustion engines will become a zero-carbon power source by using surplus renewable electricity to produce renewable fuels at low costs. The High Quality Development Plan of Internal Combustion Engine Industry (2021-2035) of China Internal Combustion Engine Industry Association states: by 2025, the research on key technologies of engines using renewable fuels such as ammonia and hydrogen will be carried out, and a new generation of technologies of natural gas and methanol fuel engines will be developed, with the effective thermal efficiency of low-carbon and carbon-neutral fuel engines reaching more than 45%. By 2030, the market promotion and application of low-carbon and carbon-neutral fuels will promote the production and application of renewable fuels and biofuels represented by alcohol, ether, ammonia and hydrogen, and the replacement rate of low-carbon and carbon-neutral fuels will reach more than 10%.

The essence of zero-carbon technology of internal combustion engines is to burn a carbon-neutral fuel to achieve zero carbon emission in the whole life cycle. Hydrogen energy has attracted much attention due to a good combustion performance, near-zero pollutant emission and the nature of being producible by renewable energy sources. Developing hydrogen energy industry is an important step to implement the Carbon Peaking and Carbon Neutrality Strategy. However, problems such as difficult storage and transportation and poor safety of hydrogen restrict the industrial development of hydrogen. Research shows that ammonia, as an efficient hydrogen storage medium, has the advantages of high energy density, easy storage and transportation in liquid state, high safety and no carbon emission. Therefore, hydrogen can be produced by renewable energy sources and then converted into ammonia to be transported to a destination, which can greatly reduce the transportation cost of hydrogen and improve the safety of transportation Ammonia is both a hydrogen energy carrier and a zero-carbon fuel. For a given volume of liquid ammonia, the hydrogen content and energy density thereof are respectively 1.7 and 1.5 times of those of liquid hydrogen with the same volume. In addition, ammonia can be synthesized using air and water through renewable energy sources such as solar energy and electric energy, and the entire preparation process has no carbon emission. China is vast in territory, and has abundant renewable energy sources such as solar energy resources and wind energy. A good industrial production base is beneficial to gradually realizing the transition from fossil energy to renewable ammonia energy. At present, a number of domestic scientific research institutions and enterprises have begun to plan the layout of hydrogen-ammonia industry chain. Relevant alliances have been established and relevant seminars have been organized by Fujian, Ningxia and other places in China as well as China Energy Investment to seize the opportunity. Therefore, developing ammonia-hydrogen fusion fuel power is in line with the current situation of China's energy pattern and the strategic adjustment in the future.

Compared with traditional transportation fuel, ammonia fuel has certain particularities: ammonia fuel is a carbon-free fuel, no CO2 or HC is produced during combustion, and only NOx need to be considered; ammonia fuel has a high octane number and a good anti-knock property, and can adapt to the operation of an engine with a high compression ratio Ammonia fuel is applied to heavy truck/ship engines. The efficiency and torque of a heavy internal combustion engine using ammonia fuel are higher than those of a diesel engine with the same displacement. However, due to the characteristics of high ignition temperature, high ignition energy, low flame propagation speed and narrow ignition concentration limit, ammonia fuel is very difficult to be controlled to burn stably and fast, which is the bottleneck problem limiting the application of ammonia fuel. Since it is easy to prepare hydrogen by ammonia, and the combustion speed of hydrogen is fast (3 m/s), a hydrogen-ammonia fusion fuel can be formed by on-board prepared hydrogen and gas ammonia, and efficient and clean combustion can be realized by adjusting the fuel ratio in real time according to the changes of engine load and speed.

Therefore, ammonia-hydrogen fuel mixture ratio control technology is the key technology for the performance of a heavy internal combustion engine using ammonia-hydrogen fuel, and an ammonia-hydrogen fusion fuel diffusion combustion control system with adjustable ammonia-hydrogen fuel reactivity is needed.

### SUMMARY

The purpose of the present invention is to provide an ammonia-hydrogen fusion fuel diffusion combustion control system based on reactivity regulation, which adopts a jet ignition device of a compact scavenging type precombustion chamber to provide a high temperature and high-pressure thermodynamic environment for the diffusion combustion of ammonia fuel in a main combustion chamber, thus to ensure the feasibility of ammonia fuel injection and diffusion combustion. According to the present invention, in the process of engine operation, hydrogen is injected into the main combustion chamber to form a controllable and highly reactive environment before the formation of a precombustion chamber jet flame. An ammonia ejector conducts injection near the top dead center according to the change of engine load, and the injection time is slightly earlier than the formation of the precombustion chamber jet flame or synchronous with the formation of the precombustion chamber jet flame, so that the ammonia fuel in the main combustion chamber is in a state of burning while injecting, thus to form a diffusion combustion mode in the main combustion chamber.

The purpose of the present invention is realized by the following technical solution:

The present invention discloses an ammonia-hydrogen fusion fuel diffusion combustion control system based on reactivity regulation, comprising an on-board ammonia-hydrogen fuel supply system, an ammonia-hydrogen fusion fuel diffusion combustion engine and an ECU;

The ammonia-hydrogen fusion fuel diffusion combustion engine adopts a method of directly injecting ammonia fuel and hydrogen into the main combustion chamber of the engine; the hydrogen injected into the main combustion chamber firstly form a hydrogen-air mixture with the air in the main combustion chamber, and then form an ammonia-hydrogen fusion fuel with the injected ammonia fuel; the manners in which the reactivity of the hydrogen-air mixture is regulated include: changing the hydrogen injection volume of the first hydrogen ejector of the ammonia-hydrogen fusion fuel diffusion combustion engine, and/or changing the injection angle of the nozzle of the first hydrogen ejector; the hydrogen required in the ammonia-hydrogen fusion fuel diffusion combustion engine is prepared by the on-board ammonia-hydrogen fuel supply system.

Specifically, the on-board ammonia-hydrogen fuel supply system comprises a low-pressure ammonia fuel supply unit and an on-board hydrogen production unit, and is used to provide prepared low-pressure ammonia fuel and hydrogen for the ammonia-hydrogen fusion fuel diffusion combustion engine; the low-pressure ammonia fuel supply unit is used to provide ammonia fuel with a pressure range of 0.5-1.0 MPa, and the on-board hydrogen production unit is used to provide hydrogen with a pressure range of 1.0-2.0 MPa;

The ammonia-hydrogen fusion fuel diffusion combustion engine comprises an engine cylinder head, a cylinder liner, a piston, a main combustion chamber, an intake channel and an exhaust channel, and also comprises a first hydrogen ejector and an ammonia ejector arranged on the cylinder head and a turbulent jet ignition device with a precombustion chamber; nozzles of the turbulent jet ignition device, the first hydrogen ejector and the ammonia ejector are extended into the main combustion chamber to directly inject ammonia fuel and hydrogen into the main combustion chamber of the engine; the hydrogen injected into the main combustion chamber firstly form a hydrogen-air mixture with the air in the main combustion chamber, and then form an ammonia-hydrogen fusion fuel with the injected ammonia fuel;

The ECU is used to control the ammonia-hydrogen fusion fuel diffusion combustion engine and the on-board ammonia-hydrogen fuel supply system, thus to control the intensity of a precombustion chamber jet flame, control the reactivity of the hydrogen-air mixture in the main combustion chamber and control the injection time of the ammonia ejector, thus to form diffusion combustion in the main combustion chamber;

The working process of the control system comprises: the ammonia fuel provided by the low-pressure ammonia fuel supply unit is divided into two branches, one branch enters the ammonia ejector through a pipeline to be injected into the main combustion chamber, and the other branch enters the on-board hydrogen production unit to participate in hydrogen production; the hydrogen prepared by the on-board hydrogen production unit is divided into two branches, one branch is injected into the main combustion chamber by the first hydrogen ejector, and the other branch is supplied to the turbulent jet ignition device and ignited by a spark plug in a precombustion chamber inner cavity, forming a precombustion chamber jet flame in the main combustion chamber; before the formation of the precombustion chamber jet flame, a certain amount of hydrogen is firstly injected into the main combustion chamber by the first hydrogen ejector, and the hydrogen injection volume thereof is regulated by the ECU, thus to form a hydrogen-air mixture with adjustable reactivity in the main combustion chamber; then the ammonia ejector is controlled by the ECU to conduct injection near the top dead center according to the change of engine load, and the injection time is slightly earlier than the formation of the precombustion chamber jet flame or synchronous with the formation of the precombustion chamber jet flame, so that the ammonia fuel injected into the main combustion chamber is in a state of burning while injecting, thus to form diffusion combustion in the main combustion chamber and complete combustion work.

Further, the low-pressure ammonia fuel supply unit comprises an ammonia storage tank, a heater, a surge tank and a pressure controller which are connected in sequence; the ammonia storage tank contains liquid ammonia; and the on-board hydrogen production unit comprises an on-board hydrogen production device, a high-pressure hydrogen storage tank and a pressure controller which are connected in sequence.

Further, an intake valve is arranged in the intake channel, an exhaust valve is arranged in the exhaust channel, and the intake valve and the exhaust valve are respectively arranged on the left and right sides of the cylinder head and used in combination with a throttle device of the engine to change the intake volume.

Further, the turbulent jet ignition device comprises a precombustion chamber inner cavity, a spark plug, an air ejector and a second hydrogen ejector; a nozzle of the air ejector is extended into the precombustion chamber inner cavity to inject air into the precombustion chamber inner cavity, and a nozzle of the second hydrogen ejector is extended into the precombustion chamber inner cavity to inject hydrogen into the precombustion chamber inner cavity; the spark plug, the nozzle of the air ejector and the nozzle of the second hydrogen ejector are arranged on the same side of the precombustion chamber; the hydrogen injection volume of the second hydrogen ejector is regulated by the ECU to control the intensity of the precombustion chamber jet flame; the turbulent jet ignition device has a jet hole in the bottom, and the precombustion chamber inner cavity is in communication with the main combustion chamber through the jet hole; the turbulent jet ignition device has two operating modes, i.e., a dual injection mode and a scavenging mode;

When the turbulent jet ignition device is controlled by the ECU to be in the dual injection mode, fresh air and hydrogen are respectively injected into the precombustion chamber inner cavity by the air ejector and the second hydrogen ejector to form an equivalent gas mixture in the precombustion chamber;

When the turbulent jet ignition device is controlled by the ECU to be in the scavenging mode, only fresh air is injected into the precombustion chamber inner cavity by the air ejector to scavenge the precombustion chamber, then hydrogen is injected, and air is injected again to form the hydrogen-air mixture.

Further, the turbulent jet ignition device comprises a precombustion chamber inner cavity, a spark plug and a second hydrogen ejector; the second hydrogen ejector is installed with a high-pressure premixing cavity and a solenoid valve downwards in sequence, and a nozzle at the bottom of the solenoid valve is extended into the precombustion chamber inner cavity to inject the hydrogen-air mixture into the precombustion chamber inner cavity; a side wall of the high-pressure premixing cavity is in communication with an air intake, which is used to premix high-pressure air and hydrogen from the second hydrogen ejector therein; a nozzle of the spark plug is extended into the precombustion chamber inner cavity; the hydrogen injection volume of the second hydrogen ejector is regulated by the ECU to control the intensity of the precombustion chamber jet flame; the turbulent jet ignition device has a jet hole in the bottom, and the precombustion chamber inner cavity is in communication with the main combustion chamber through the jet hole; the turbulent jet ignition device has two operating modes, i.e., an air-forced injection mode and a scavenging mode;

When the turbulent jet ignition device is controlled by the ECU to be in the air-forced injection mode, the hydrogen and high-pressure air in the second hydrogen ejector are mixed in the high-pressure premixing cavity, and a hydrogen-air mixture is injected by the solenoid valve to form an equivalent gas mixture in the precombustion chamber;

When the turbulent jet ignition device is controlled by the ECU to be in the scavenging mode, injection is conducted twice by the solenoid valve, and in the first time, fresh air is injected into the precombustion chamber inner cavity to scavenge the precombustion chamber; then, the hydrogen and high-pressure air in the second hydrogen ejector are mixed in the high-pressure premixing cavity to form a hydrogen-air mixture, and the mixture is injected into the precombustion chamber by the solenoid valve in the second time.

Further, the formation time of the precombustion chamber jet flame is controlled by the ignition time of a spark plug 12 of a turbulent jet ignition device 5.

Further, the ammonia ejector is a low-pressure liquid ammonia ejector, and the first hydrogen ejector is provided with a low-pressure hydrogen nozzle.

Further, the on-board hydrogen production device by ammonia is heated by the engine waste heat of the ammonia-hydrogen fusion fuel diffusion combustion engine to promote the on-board hydrogen production process, or a separate electric heating device is installed for heat supply.
Compared with the prior art, the technical solution of the present invention has the following beneficial effects:
1. The reactivity and diffusion combustion process of the engine is collaboratively controlled by the hydrogen injection volume in the precombustion chamber and the hydrogen injection volume in the main combustion chamber, the intensity of the jet flame is controlled by the hydrogen injection volume in the precombustion chamber, the reactivity of the gas mixture is controlled by the hydrogen injection of the main combustion chamber, and the reactivity in the combustion chamber can be controlled by low-pressure hydrogen injection in the cylinder, thus to further improve the capacity of diffusion combustion and finally realize the efficient and stable combustion of a pure ammonia engine in multiple working conditions with a wide load range;
2. By adjusting the hydrogen injection volume and/or injection angle of the hydrogen injected into the main combustion chamber, the reactivity of the gas mixture in the main combustion chamber is adjusted, and the ammonia injection time is slightly earlier than or synchronous with the formation of the jet flame, thus to solve the problems of difficult ignition and low combustion speed of gas ammonia.

### DESCRIPTION OF DRAWINGS

FIG. 1 is a schematic diagram of an ammonia-hydrogen fusion fuel diffusion combustion control system based on reactivity regulation;

FIG. 2 is a structural schematic diagram of an ammonia-hydrogen fusion fuel engine of embodiment 1;

FIG. 3 is a sectional view of a jet ignition device of embodiment 1;

FIG. 4 is a sectional view of a jet ignition device of embodiment 2;

In the figures:
1: piston; 2: main combustion chamber; 3: intake valve;
4: first hydrogen ejector; 5: turbulent jet ignition device; 6: jet flame;
7: ammonia ejector; 8: exhaust valve; 9: cylinder head;
10: cylinder liner; 11, 21: precombustion chamber inner cavity; 12, 16: spark plug;
13: air ejector; 14: compaction bolt; 15, 17: second hydrogen ejector;
18: high-pressure premixing cavity; 19: air intake; 20: solenoid valve.

### DETAILED DESCRIPTION

To make the purpose, the technical solution, the beneficial effects and the obvious advantages of the embodiments of the present invention more clear, the technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

The hydrogen required in the ammonia-hydrogen fusion fuel diffusion combustion control system based on reactivity regulation proposed by the present invention is from the on-board hydrogen production device and is prepared by gas ammonia; and the ammonia-hydrogen fusion fuel with controllable reactivity is formed by direct injection of ammonia fuel and hydrogen in the cylinder. At the same time, the prepared hydrogen can be supplied to the precombustion chamber as a fuel of the precombustion chamber. Matched with the turbulent jet ignition device, the jet flame can be formed to improve the ignition performance of the engine. During engine operation, the reactivity in the main combustion chamber is regulated by controlling the hydrogen injection volume in the cylinder, and the diffusion combustion mode is formed in the main combustion chamber by controlling the precombustion chamber jet flame and the ammonia fuel injection time in the main combustion chamber. The intensity of the precombustion chamber jet flame is controlled by the hydrogen injection volume in the precombustion chamber, and the formation time of the precombustion chamber jet flame is controlled by the ignition time of the spark plug in the precombustion chamber. The working process of the device is further described below in combination with the drawings.

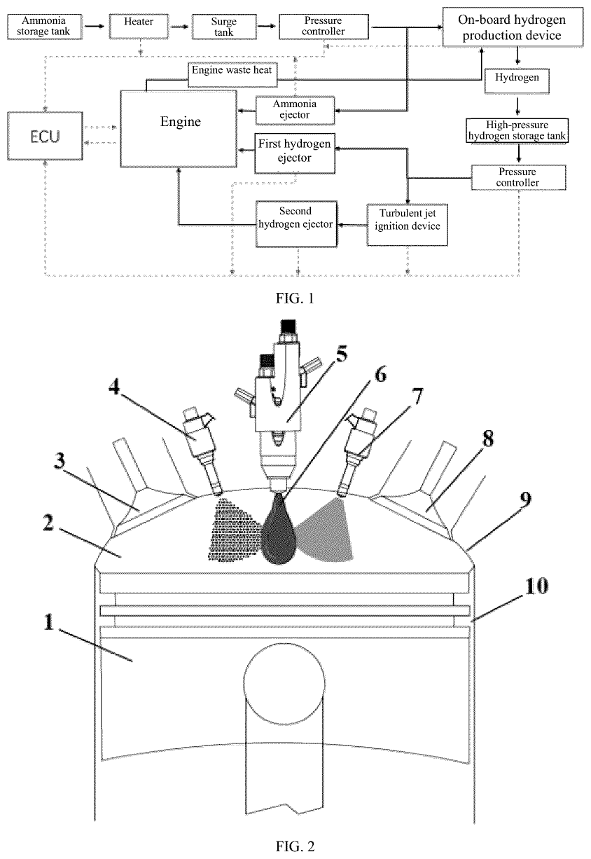

FIG. 1 shows an ammonia-hydrogen fusion fuel diffusion combustion control system based on reactivity regulation, comprising an on-board ammonia-hydrogen fuel supply system, an ammonia-hydrogen fusion fuel diffusion combustion engine and an ECU;

The on-board ammonia-hydrogen fuel supply system comprises a low-pressure ammonia fuel supply unit and an on-board hydrogen production unit; the low-pressure ammonia fuel supply unit is used to provide low-pressure ammonia fuel with a pressure range of 0.5-1.0 MPa, and comprises an ammonia storage tank, a heater, a surge tank and a pressure controller which are connected in sequence; the ammonia storage tank contains ammonia fuel; the pressure controller is used to adjust the ammonia fuel from the surge tank, and the ammonia fuel may be gas ammonia or liquid ammonia. The on-board hydrogen production unit is used to provide low-pressure hydrogen with a pressure range of 1.0-2.0 MPa, and comprises an on-board hydrogen production device, a high-pressure hydrogen storage tank and a pressure controller which are connected in sequence; the hydrogen prepared by the on-board hydrogen production device is firstly stored in the high-pressure hydrogen storage tank and then enters the pressure controller for pressure control of ammonia fuel/hydrogen, the output pressure of the low-pressure ammonia fuel supply unit is preferred to be 0.8 MPa, and the output pressure of on-board hydrogen production unit is preferred to be 1.0 MPa. One branch of the low-pressure ammonia fuel is supplied to an ammonia ejector 7 of the ammonia-hydrogen fusion fuel diffusion combustion engine, and the other branch is supplied to the on-board hydrogen production unit; the low-pressure hydrogen prepared is divided into two branches and supplied to the ammonia-hydrogen fusion fuel diffusion combustion engine, one branch is supplied to a first hydrogen ejector 4 to participate in combustion work, and the other branch is supplied to a turbulent jet ignition device 5 to participate in the formation of a precombustion chamber jet flame. Engine waste heat can be supplied to the on-board hydrogen production device by ammonia to accelerate the preparation of hydrogen, and the on-board hydrogen production device by ammonia can also be supplied with heat by installing an electric heating device.

The ECU is used to control the ammonia-hydrogen fusion fuel diffusion combustion engine, the on-board hydrogen production device and the pressure controller, regulate the injection volume and pressure of the ammonia fuel and hydrogen to be injected into the ammonia-hydrogen fusion fuel diffusion combustion engine, and regulate the injection time of the ammonia ejector 7 in the ammonia-hydrogen fusion fuel diffusion combustion engine, thus to form diffusion combustion in the main combustion chamber 2.

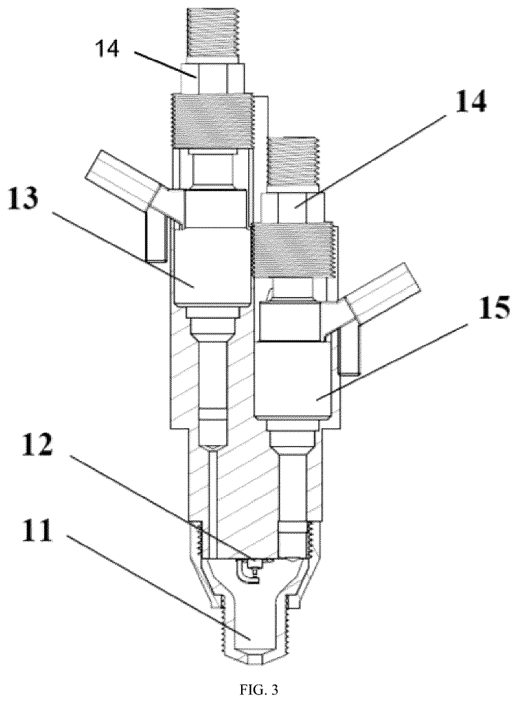

As shown in FIG. 2, the ammonia-hydrogen fusion fuel diffusion combustion engine comprises a cylinder liner 10 and an engine cylinder head 9 arranged on top of the cylinder liner 10, the top of the engine cylinder head 9 is provided with an intake valve 3, an exhaust valve 8, the first hydrogen ejector 4, the ammonia ejector 7 and the turbulent jet ignition device 5; the intake valve 3 is arranged in an intake channel, the exhaust valve 8 is arranged in an exhaust channel, and the intake valve 3 and the exhaust valve 8 are respectively arranged on the left and right sides of the cylinder head; a piston 1 is arranged in the cylinder liner 10; the intake valve 3 and the exhaust valve 8 are used in combination with a throttle device of the ammonia-hydrogen fusion fuel diffusion combustion engine to change the intake volume. The engine cylinder head, the turbulent jet ignition device 5 and the piston 1 jointly form the main combustion chamber 2, and the turbulent jet ignition device 5 is located directly above the main combustion chamber. The first hydrogen ejector 4 and the ammonia ejector 7 can be installed at flexible angles, it is preferred that an angle of 45 degree is formed between the first hydrogen ejector 4 and a nozzle of the turbulent jet ignition device 5, and hydrogen-air mixtures with different reactivities can be formed in the jet ignition direction and ammonia fuel injection direction of the main combustion chamber by changing the injection angle of a nozzle of the first hydrogen ejector 4; nozzles of the turbulent jet ignition device 5, the first hydrogen ejector 4 and the ammonia ejector 7 are extended into the main combustion chamber 2, the hydrogen injected into the main combustion chamber firstly form a hydrogen-air mixture with the air in the main combustion chamber, and then form an ammonia-hydrogen fusion fuel with the injected ammonia fuel; before the ammonia fuel is injected into the main combustion chamber 2, the reactivity of the hydrogen-air mixture can be regulated by changing the hydrogen injection volume of the first hydrogen ejector 4. When the hydrogen injection volume is increased, the reactivity of the hydrogen-air mixture is increased, otherwise, the reactivity of the hydrogen-air mixture is decreased. The first hydrogen ejector 4 is controlled cooperatively by the ECU and a fuel injection system of the engine to realize regulation.

The ammonia ejector 7 is a low-pressure liquid ammonia ejector, and the first hydrogen ejector 4 is provided with a low-pressure hydrogen nozzle.

As shown in FIG. 3, the turbulent jet ignition device 5 is configured with a dual injection type precombustion chamber to form a turbulent jet ignition device with a scavenging function, and comprises a shell; the bottom of the shell is installed on the engine cylinder head 9 through screw threads; an air ejector 13 and a second hydrogen ejector 15 in vertical arrangement are installed in the shell, the air ejector 13 and the second hydrogen ejector 15 are respectively fixed on the shell by a compaction bolt 14, each compaction bolt has a through hole and has screw threads on both ends, one end of the compaction bolt is connected with the shell by crew threads and used to fix the air ejector 13 or the second hydrogen ejector 15, the other end of the compaction bolt is used to connect a gas path, and the through hole of the compaction bolt is used to supply air to the air ejector 13 or supply hydrogen to the second hydrogen ejector 15. A precombustion chamber inner cavity 11 is formed at the lower part of the shell, a spark plug 12 is installed at the top of the precombustion chamber inner cavity, an electrode of the spark plug 12 is extended into the precombustion chamber, and the formation time of a jet flame 6 can be controlled by controlling the ignition time of the spark plug 12; the spark plug, the nozzle of the air ejector and the nozzle of the second hydrogen ejector are arranged on the same side of the precombustion chamber; the shell has a jet hole in the bottom, and the precombustion chamber is in communication with the main combustion chamber through the jet hole. The air ejector and the second hydrogen ejector are controlled cooperatively by the ECU and the fuel injection system of the engine to realize regulation. The jet hole is used to realize accelerated flame propagation, improve the combustion rate, and thus to improve the economical performance of the engine.

In combination with FIG. 1, the present invention has the working process that:

When the turbulent jet ignition device 5 is controlled by the ECU to be in a dual injection mode, the ammonia fuel in the ammonia storage tank flows successively through the heater, the surge tank and the pressure controller; the ECU is used to regulate the pressure of the ammonia fuel in the pressure controller to be 0.5-1.0 MPa, then the ammonia fuel is divided into two branches, one branch enters the ammonia ejector 7 through a pipeline, the time when the branch is directly injected into the main combustion chamber 2 is controlled by the ECU, and the other branch enters the on-board hydrogen production device in the on-board hydrogen production unit. The hydrogen prepared by the on-board hydrogen production device flows successively through the high-pressure hydrogen storage tank and the pressure controller, the ECU is used to regulate the pressure of the hydrogen in the pressure controller to be 1.0-2.0 MPa, then the hydrogen is divided into two branches, one branch is directly injected into the main combustion chamber 2 by the first hydrogen ejector 4, the other branch is supplied to the turbulent jet ignition device 5, i.e., injected into the precombustion chamber inner cavity 11 by the second hydrogen ejector 15, and fresh air is also injected into the precombustion chamber inner cavity 11 by air ejector 13 to cooperate with the hydrogen injected into the precombustion chamber inner cavity 11 to form an equivalent gas mixture and then ignited by the spark plug 12 to form a precombustion chamber jet flame 6 in the main combustion chamber 2; the formation time of the precombustion chamber jet flame 6 is controlled by the ignition time of the spark plug 12 in the precombustion chamber; before the formation of the precombustion chamber jet flame 6, a certain amount of hydrogen is firstly injected into the main combustion chamber by the first hydrogen ejector 4, the hydrogen injection volume of the first hydrogen ejector 4 is regulated by the ECU to control the reactivity of the hydrogen-air mixture in the main combustion chamber, then the ammonia ejector 7 is controlled by the ECU to conduct injection near the top dead center according to the change of engine load, and the injection time is slightly earlier than the formation of the precombustion chamber jet flame 6 or synchronous with the formation of the precombustion chamber jet flame 6, so that the ammonia fuel in the main combustion chamber is in a state of burning while injecting, thus to form a diffusion combustion mode in the main combustion chamber 2 and complete combustion work. The intensity of the precombustion chamber jet flame 6 is controlled by regulating the hydrogen injection volume of the second hydrogen ejector 15 through the ECU. In the process of engine operation, the first hydrogen ejector is regulated according to the operating condition and working load of the engine, thus to regulate the reactivity of the working medium in the cylinder.

When the turbulent jet ignition device 5 is controlled by the ECU to be in the scavenging mode, a single air injection is conducted by the air ejector 13 in advance based on the dual injection mode to scavenge the precombustion chamber inner cavity 11. When the gas mixture in the main combustion chamber 2 is too thick or the engine is operating at a high EGR rate, the influence of ammonia or waste gas in the main combustion chamber 2 on the ignition and combustion of the hydrogen-air mixture in the precombustion chamber can be eliminated by the scavenging process, thus to ensure the jet ignition intensity and finally realize the stable ignition of the engine.

At the same time, the engine waste heat is used to supply heat to the on-board hydrogen production device by ammonia, and the on-board hydrogen production device by ammonia can also be supplied with heat by the installed electric heating device. The dashed line in FIG. 1 indicates a transmission route of a signal received or sent by the ECU.

### Embodiment 2

Similar to embodiment 1 in structure, only the turbulent jet ignition device 5 has a slightly different structure. However, the difference in this embodiment lies in that an equivalent hydrogen-air mixture premixed in advance is injected into the precombustion chamber inner cavity, thus to make the jet ignition more stable. Only distinguishing features are described below.

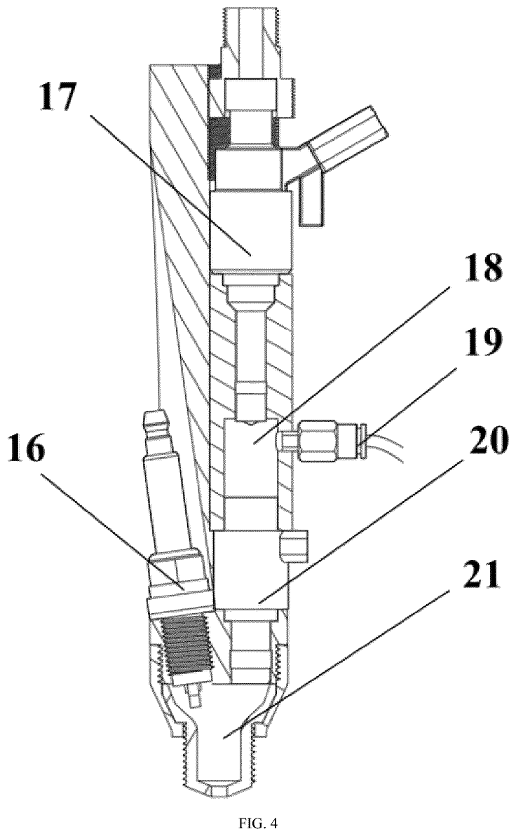

The turbulent jet ignition device 5 is configured with an air-forced injection type precombustion chamber to form a turbulent jet ignition device with a scavenging process, and comprises a spark plug 16, a second hydrogen ejector 17, a high-pressure premixing cavity 18, an air intake 19, a solenoid valve 20, and a precombustion chamber inner cavity 21. As shown in FIG. 4, the turbulent jet ignition device 5 comprises a shell; the bottom of the shell is installed on the engine cylinder head 9 through screw threads; the second hydrogen ejector 17, the high-pressure premixing cavity 18 and the solenoid valve 20 are installed in the shell from top to bottom in sequence; a side wall of the high-pressure premixing cavity 18 is in communication with the air intake 19, which is used to premix high-pressure air and hydrogen from the second hydrogen ejector 17 therein; a precombustion chamber inner cavity 21 is formed at the lower part of the shell, a spark plug 16 is installed in the shell, and an electrode of the spark plug 16 as well as an outlet at the bottom of the solenoid valve 20 are extended into the precombustion chamber inner cavity; the shell has a jet hole in the bottom; the jet hole is used to realize accelerated flame propagation, improve the combustion rate, and thus to improve the economical performance of the engine.

The present invention has the working process that: when the turbulent jet ignition device is controlled by the ECU to be in an air-forced injection mode, the ammonia fuel prepared by the low-pressure ammonia fuel supply unit is divided into two branches, one branch enters the ammonia ejector 7 through a pipeline, the time when the branch is directly injected into the main combustion chamber 2 is controlled by the ECU, and the other branch enters the on-board hydrogen production device in the on-board hydrogen production unit. The hydrogen prepared by the on-board hydrogen production device is divided into two branches, one branch is directly injected into the main combustion chamber 2 by the first hydrogen ejector 4, the other branch is supplied to the second hydrogen ejector 17 of the turbulent jet ignition device 5, hydrogen from the second hydrogen ejector 17 and high-pressure air from the air intake 19 are premixed in the high-pressure premixing cavity 18 to form an equivalent homogeneous premixed gas, and the homogeneous premixed gas is injected into the precombustion chamber inner cavity 21 by the solenoid valve 20 and then ignited by the spark plug 16 to form a precombustion chamber jet flame 6 in the main combustion chamber 2; the formation time of the precombustion chamber jet flame 6 is controlled by the ignition time of the spark plug 12 in the precombustion chamber; before the formation of the precombustion chamber jet flame 6, a certain amount of hydrogen is firstly injected into the main combustion chamber by the first hydrogen ejector 4, thus to form a hydrogen-air mixture with adjustable reactivity in the main combustion chamber; the hydrogen injection volume of the first hydrogen ejector 4 is regulated by the ECU to control the reactivity of the hydrogen-air mixture in the main combustion chamber, then the ammonia ejector 7 is controlled by the ECU to conduct injection near the top dead center according to the change of engine load, and the injection time is slightly earlier than the formation of the precombustion chamber jet flame 6 or synchronous with the formation of the precombustion chamber jet flame 6, so that the ammonia fuel in the main combustion chamber is in a state of burning while injecting, thus to form a diffusion combustion mode in the main combustion chamber 2 and complete combustion work. The intensity of the precombustion chamber jet flame 6 is controlled by regulating the hydrogen injection volume of the second hydrogen ejector 15 through the ECU. In the process of engine operation, the first hydrogen ejector is regulated according to the operating condition and working load of the engine, thus to regulate the reactivity of the working medium in the cylinder.

When the turbulent jet ignition device 5 is controlled by the ECU to be in the scavenging mode (except for the different working process of the turbulent jet ignition device 5, the other processes are the same as those in the air-forced injection mode, so it will not be repeated herein), injection is conducted twice by the solenoid valve, and in the first time, fresh air is injected into the precombustion chamber inner cavity 21 to scavenge the precombustion chamber inner cavity 21; then, the hydrogen and high-pressure air in the second hydrogen ejector 17 are mixed in the high-pressure premixing cavity 18 to form a hydrogen-air mixture, and the mixture is injected into the precombustion chamber inner cavity 21 by the solenoid valve in the second time.

The above embodiments are only used for describing, rather than limiting the technical solution of the present invention. Although the present invention is described in detail by referring to the above embodiments, those ordinary skilled in the art should understand that amendments to the technical solution recorded in each of the above embodiments or equivalent replacements for part or all the technical features therein may still be made, but such amendments or replacements do not enable the essence of the corresponding technical solution to depart from the scope of the technical solution of various embodiments of the present invention. Non-essential improvements and adjustments or replacements made by those skilled in the art according to the contents of the description shall belong to the protection scope of the present invention.

1. An ammonia-hydrogen fusion fuel diffusion combustion control system based on reactivity regulation, comprising an on-board ammonia-hydrogen fuel supply system, an ammonia-hydrogen fusion fuel diffusion combustion engine and an ECU;
the on-board ammonia-hydrogen fuel supply system comprises a low-pressure ammonia fuel supply unit and an on-board hydrogen production unit, and is used to provide prepared low-pressure ammonia fuel and hydrogen for the ammonia-hydrogen fusion fuel diffusion combustion engine; the low-pressure ammonia fuel supply unit is used to provide ammonia fuel with a pressure range of 0.5-1.0 MPa, and the on-board hydrogen production unit is used to provide hydrogen with a pressure range of 1.0-2.0 MPa;
the ammonia-hydrogen fusion fuel diffusion combustion engine comprises an engine cylinder head (9), a cylinder liner (10), a piston (1), a main combustion chamber (2), an intake channel and an exhaust channel, and also comprises a first hydrogen ejector (4) and an ammonia ejector (7) arranged on the cylinder head and a turbulent jet ignition device (5) with a precombustion chamber; nozzles of the turbulent jet ignition device (5), the first hydrogen ejector (4) and the ammonia ejector (7) are extended into the main combustion chamber (2) to directly inject ammonia fuel and hydrogen into the main combustion chamber of the engine; the hydrogen injected into the main combustion chamber firstly form a hydrogen-air mixture with the air in the main combustion chamber, and then form an ammonia-hydrogen fusion fuel with the injected ammonia fuel; the manners in which the reactivity of the hydrogen-air mixture is regulated include: changing the hydrogen injection volume of the first hydrogen ejector of the ammonia-hydrogen fusion fuel diffusion combustion engine, and/or changing the injection angle of the nozzle of the first hydrogen ejector;
the ECU is used to control the ammonia-hydrogen fusion fuel diffusion combustion engine and the on-board ammonia-hydrogen fuel supply system, thus to control the intensity of a precombustion chamber jet flame, control the reactivity of the hydrogen-air mixture in the main combustion chamber and control the injection time of the ammonia ejector (7), thus to form diffusion combustion in the main combustion chamber (2);
the working process of the control system comprises: the ammonia fuel provided by the low-pressure ammonia fuel supply unit is divided into two branches, one branch enters the ammonia ejector (7) through a pipeline to be injected into the main combustion chamber, and the other branch enters the on-board hydrogen production unit to participate in hydrogen production; the hydrogen prepared by the on-board hydrogen production unit is divided into two branches, one branch is injected into the main combustion chamber by the first hydrogen ejector (4), and the other branch is supplied to the turbulent jet ignition device (5) and ignited by a spark plug in a precombustion chamber inner cavity, forming a precombustion chamber jet flame (6) in the main combustion chamber; before the formation of the precombustion chamber jet flame (6), a certain amount of hydrogen is firstly injected into the main combustion chamber by the first hydrogen ejector (4), and the hydrogen injection volume thereof is regulated by the ECU, thus to form a hydrogen-air mixture with adjustable reactivity in the main combustion chamber (2); then the ammonia ejector (7) is controlled by the ECU to conduct injection near the top dead center according to the change of engine load, and the injection time is slightly earlier than the formation of the precombustion chamber jet flame (6) or synchronous with the formation of the precombustion chamber jet flame (6), so that the ammonia fuel injected into the main combustion chamber (2) is in a state of burning while injecting, thus to form diffusion combustion in the main combustion chamber (2) and complete combustion work.

2. The ammonia-hydrogen fusion fuel diffusion combustion control system based on reactivity regulation according to claim 1, wherein the low-pressure ammonia fuel supply unit comprises an ammonia storage tank, a heater, a surge tank and a pressure controller which are connected in sequence; the ammonia storage tank contains liquid ammonia; and the on-board hydrogen production unit comprises an on-board hydrogen production device, a high-pressure hydrogen storage tank and a pressure controller which are connected in sequence.

3. The ammonia-hydrogen fusion fuel diffusion combustion control system based on reactivity regulation according to claim 1, wherein an intake valve (3) is arranged in the intake channel, an exhaust valve (8) is arranged in the exhaust channel, and the intake valve and the exhaust valve are respectively arranged on the left and right sides of the cylinder head and used in combination with a throttle device of the engine to change the intake volume.

4. The ammonia-hydrogen fusion fuel diffusion combustion control system based on reactivity regulation according to claim 1, wherein the turbulent jet ignition device (5) comprises a precombustion chamber inner cavity (11), a spark plug (12), an air ejector (13) and a second hydrogen ejector (15); a nozzle of the air ejector (13) is extended into the precombustion chamber inner cavity (11) to inject air into the precombustion chamber inner cavity (11), and a nozzle of the second hydrogen ejector (15) is extended into the precombustion chamber inner cavity (11) to inject hydrogen into the precombustion chamber inner cavity (11); the spark plug (12), the nozzle of the air ejector and the nozzle of the second hydrogen ejector are arranged on the same side of the precombustion chamber; the hydrogen injection volume of the second hydrogen ejector (15) is regulated by the ECU to control the intensity of the precombustion chamber jet flame; the turbulent jet ignition device (5) has a jet hole in the bottom, and the precombustion chamber inner cavity is in communication with the main combustion chamber through the jet hole; the turbulent jet ignition device has two operating modes, i.e., a dual injection mode and a scavenging mode;
when the turbulent jet ignition device is controlled by the ECU to be in the dual injection mode, fresh air and hydrogen are respectively injected into the precombustion chamber inner cavity (11) by the air ejector (13) and the second hydrogen ejector (15) to form an equivalent gas mixture in the precombustion chamber;
when the turbulent jet ignition device is controlled by the ECU to be in the scavenging mode, only fresh air is injected into the precombustion chamber inner cavity by the air ejector (13) to scavenge the precombustion chamber, then hydrogen is injected, and air is injected again to form the hydrogen-air mixture.

5. The ammonia-hydrogen fusion fuel diffusion combustion control system based on reactivity regulation according to claim 1, wherein the turbulent jet ignition device (5) comprises a precombustion chamber inner cavity (21), a spark plug (16) and a second hydrogen ejector (17); the second hydrogen ejector (17) is installed with a high-pressure premixing cavity (18) and a solenoid valve (20) downwards in sequence, and a nozzle at the bottom of the solenoid valve (20) is extended into the precombustion chamber inner cavity (21) to inject the hydrogen-air mixture into the precombustion chamber inner cavity (21); a side wall of the high-pressure premixing cavity (18) is in communication with an air intake (19), which is used to premix high-pressure air and hydrogen from the second hydrogen ejector therein; a nozzle of the spark plug (16) is extended into the precombustion chamber inner cavity; the hydrogen injection volume of the second hydrogen ejector (17) is regulated by the ECU to control the intensity of the precombustion chamber jet flame; the turbulent jet ignition device (5) has a jet hole in the bottom, and the precombustion chamber inner cavity is in communication with the main combustion chamber through the jet hole; the turbulent jet ignition device has two operating modes, i.e., an air-forced injection mode and a scavenging mode;
when the turbulent jet ignition device is controlled by the ECU to be in the air-forced injection mode, the hydrogen and high-pressure air in the second hydrogen ejector (17) are mixed in the high-pressure premixing cavity, and a hydrogen-air mixture is injected by the solenoid valve (20) to form an equivalent gas mixture in the precombustion chamber;
when the turbulent jet ignition device is controlled by the ECU to be in the scavenging mode, injection is conducted twice by the solenoid valve (20), and in the first time, fresh air is injected into the precombustion chamber inner cavity to scavenge the precombustion chamber; then, the hydrogen and high-pressure air in the second hydrogen ejector (17) are mixed in the high-pressure premixing cavity to form a hydrogen-air mixture, and the mixture is injected into the precombustion chamber by the solenoid valve in the second time.

6. The ammonia-hydrogen fusion fuel diffusion combustion control system based on reactivity regulation according to claim 1, wherein the formation time of the precombustion chamber jet flame (6) is controlled by the ignition time of the spark plug (12) of the turbulent jet ignition device (5).

7. The ammonia-hydrogen fusion fuel diffusion combustion control system based on reactivity regulation according to claim 1, wherein the ammonia ejector (7) is a low-pressure liquid ammonia ejector, and the first hydrogen ejector (4) is provided with a low-pressure hydrogen nozzle.

8. The ammonia-hydrogen fusion fuel diffusion combustion control system based on reactivity regulation according to claim 1, wherein the on-board hydrogen production device by ammonia is heated by the engine waste heat of the ammonia-hydrogen fusion fuel diffusion combustion engine to promote the on-board hydrogen production process, or a separate electric heating device is installed for heat supply.
